(19) United States
(12) Patent Application Publication
(10) Pub. No.: US 2014/0042656 A1
(43) Pub. Date: Feb. 13, 2014

(54) LEFTOVER CONCRETE RECYCLING DEVICE AND METHOD FOR LEFTOVER CONCRETE RECYCLING

(71) Applicant: LINTEC GmbH & Co. KG, Buxtehude (DE)

(72) Inventor: Max F. SCHURAN, Seevetal (DE)

(73) Assignee: LINTEC GmbH & Co. KG, Buxtehude (DE)

(21) Appl. No.: 13/962,864

(22) Filed: Aug. 8, 2013

(30) Foreign Application Priority Data
Aug. 10, 2012 (DE) 20 2012 007 655.8

(51) Int. Cl. B28B 15/00

(52) U.S. Cl. CPC B28B 15/002
USPC 264/37.19; 425/62

(57) ABSTRACT

The invention relates to a compact leftover concrete recycling device for mobile use on a concrete transportation vehicle and/or concrete delivery vehicle, comprising a recycling chamber with a baffle plate, an inlet opening for leftover concrete and an outlet opening for recycled leftover concrete as well as two, three or more high-pressure nozzles, wherein the baffle plate, the inlet opening and the outlet opening are designed and arranged such that leftover concrete filled into the recycling chamber through the inlet opening impacts a reception section of the baffle plate, passes a recycling section of the baffle plate and then leaves the recycling chamber through the outlet opening, and wherein the high-pressure nozzles are arranged and designed such that water jets delivered from the high-pressure nozzles impact the recycling section of the baffle plate.

The invention relates to a leftover concrete recycling device and a method for leftover concrete recycling.

The fresh concrete used, for example, at construction sites is transported to its processing site normally by concrete transportation vehicles and/or concrete delivery vehicles, such as truck mixers, truck mixer pumps, truck-mounted concrete pumps or mobile shotcrete machines. Also the fresh concrete processed, for example, at a precast plant is transported by stationary or mobile conveyor systems.

In connection with the transportation and processing of fresh concrete, residual amounts of concrete—so-called leftover concrete—accrue normally at the beginning and at the end of concreting. This leftover concrete cannot be used as intended but must be disposed of. At the beginning of concreting, such leftover concrete to be disposed of, is, for example, the concrete supplied by the concrete pump at the beginning of concreting. Normally, such initially supplied concrete will not yet show the properties and compositions required for processing at the construction site, because this initial concrete amount must first pass through the pipes or hoses that are provided for delivering the concrete from the concrete pump, where a thin film consisting, in particular, of cement paste and water will often deposit on the inner surface of the pipes or hoses, which will then of course be missing, as a component, from the initial concrete leaving the pipe or hose. Also, at the end of concreting, a residual amount of mixed fresh concrete will most often remain in the concrete transportation or concrete delivery vehicle or in the concrete pump. That residual amount is no longer required and therefore must be disposed of, as well. Such residual amounts have a volume of, for example, 0.5 to 1.5 m³.

Because of the properties of its components and their interaction, fresh concrete has so-called setting and hardening properties. Setting means when fresh concrete goes from a liquid, plastic state to a solid state due to hydration of the cement paste. Continued hydration makes the concrete hard, i.e. it acquires a specific compressive strength. Because of these setting and hardening properties, fresh concrete must be quickly removed from all tools and equipment used and from the concrete transportation or concrete delivery vehicles or pump pipes. If the concrete starts to harden while still inside the concrete transportation or concrete delivery truck or in the pump pipes, removal or disposal is normally no longer possible, and the concrete transportation or concrete delivery truck or the concrete pump will become permanently unusable. Since there is only a certain time window available between mixing the concrete and the concrete starting to set or harden, there is only little time available to dispose of the leftover concrete, once the fresh concrete has been used as intended at the construction site or precast plant.

Therefore, in practice, the leftover concrete obtained from a concrete transportation or concrete delivery truck or from a concrete pump at the beginning and end of concreting is often emptied into the environment, for example into an excavation pit surrounding the construction site. Once the leftover concrete has hardened there, it will often remain in the ground and be sapped into the ground when the pit is closed. This kind of leftover concrete disposal is, on the one hand, unwanted, and, on the other, impossible at many construction sites or at a precast plant. There are, hence, concrete recycling devices that serve to separate the components that have been mixed in the production of fresh concrete, and to make them available for the production of new fresh concrete. Such systems are set up, for example, at large construction sites or precast plants. What is important is for such a concrete recycling device to be accessible for the provision of fresh concrete before it becomes hard.

Common concrete recycling devices work on the principle of washing the concrete. To that end, the leftover concrete to be reused is mixed with a large amount of water in large washing drums, where energy is supplied via mixers or rotating screws to make the cement paste come off the aggregates in the heavily diluted leftover concrete by applying mechanical shear forces. This requires, in particular, the addition of large amounts of water and complying with a specific water/leftover-concrete ratio to prevent the concrete from setting and hardening. The various concrete components are removed separately from this water/leftover-concrete mixture, for example by means of grading screens, slant dewatering or delivery screws or vibrating screen separators, and are then available again preferably for the production of fresh concrete.

Such concrete recycling devices are known, for example, from DE 197 38 471 A1 or DE 297 23 981 U1, which describe, for example, to design the system parts as modular units, so as to allow for the parts of the overall system to be arranged variably. A concrete recycling device is also known from GB 2301543 A, where leftover concrete is first heavily diluted in a washing tank. The water/leftover-concrete mixture is then given onto a vibrating screen to be broken down into its components, wherein another, additional washing of the concrete may take place on said vibrating screen.

DE 24 18 430 A1 describes a concrete washing system that is aimed at being capable of being accommodated in a smaller space than common recycling systems, and being transportable. To that end, DE 24 18 430 A1 provides for initially conveying the leftover concrete through a screw and for, meanwhile, washing the aggregates out of the cement water by adding water spray and discharging the cement water through a screen. This cement water is then separated into gray water and cement slurry in a centrifuge. The washed-out aggregates are discharged once they leave the screw. From WO 94/22581 A1 we also know a concrete recycling device, where the leftover concrete is given into a rotating drum screen, where it is sprayed with water and then broken down into its components by feeding it through different-sized screens and thus removing the cement water and the aggregates according to their particle size. We also know a concrete recycling device called VIBROWASH by CIFA S.p.A., where the leftover concrete is given onto a vibrating screen and sprayed with water while being conveyed on the vibrating screen, in order to wash it. During that process, water, cement and fines fall into a tank that is located underneath the vibrating screen, while the washed-out aggregates remaining on the vibrating screen are removed. The water/cement/fines mixture in the tank is kept in motion by mixers.

Existing concrete recycling devices have the disadvantage of requiring large amounts of water to recycle a certain amount of leftover concrete, which is due to the principle of washing out or rather diluting the leftover concrete. Also, existing concrete recycling devices work on the principle of breaking down the leftover concrete into its original components as quickly as possible and, in particular, eliminating the coarse concrete aggregates as quickly as possible and washing off the cement paste and discharging it after it is separated from the other components. Another disadvantage is that the systems require a lot of space. The systems described in DE 197 38 471 A1, DE 297 23 981 U1 and DE 24 18 430 A1 may be transported, but they still require lots of space at a construction site or precast plant.

It is therefore an object of the present invention to provide a leftover concrete recycling device that will reduce or eliminate one or more of the above disadvantages. One particular object of the present invention is to provide a leftover concrete recycling device that can be transported on a concrete transportation vehicle and/or concrete delivery vehicle and used at the changing sites of the concrete transportation vehicle and/or concrete delivery vehicle. Another object of the present invention is to provide a corresponding method for leftover concrete recycling.

This object is solved according to the invention in form of a compact leftover concrete recycling device for mobile use on a concrete transportation vehicle and/or concrete delivery vehicle, comprising a recycling chamber with a baffle plate, an inlet opening for leftover concrete and an outlet opening for recycled leftover concrete, as well as two, three or more high-pressure nozzles, wherein the baffle plate, the inlet opening and the outlet opening are designed and arranged such that the leftover concrete filled through the inlet opening into the recycling chamber impacts a reception section of the baffle plate, passes a recycling section of the baffle plate and leaves the recycling chamber through the outlet opening, wherein high-pressure nozzles are arranged and designed such that the water jets coming from the high-pressure nozzles impact the baffle plate's recycling section.

The invention is based on the finding that leftover concrete loses its setting and hardening property once the cement paste is separated from the concrete aggregates and such mechanical separation of the cement paste and aggregates can be achieved by treating the leftover concrete with high-pressure water jets. This makes redundant the heavy dilution of the leftover concrete, which we know from prior art, and the spatial separation of the components—especially the separation of aggregates and cement paste by, for example, washing the cement paste through a screen to prevent the concrete from becoming hard. After this treatment with high-pressure water jets, the leftover concrete recycled in a device according to the invention can be rather transported even further and/or stored, without such leftover concrete becoming stiff and/or hard. The leftover concrete recycling device is particularly suited and designed to recycle leftover concrete that results from the pumpable fresh concrete of a concrete conveyor system or concrete delivery vehicle.

To achieve this, the leftover concrete recycling device according to the invention provides for treating the leftover concrete with water jets from high-pressure nozzles. The high-pressure nozzles can thus also be referred to as working or recycling nozzles, since the leftover concrete is recycled by the water jets ejected by said nozzles. High pressure in terms of the present invention means, in particular, a pressure of at least 1 MPa, preferably at least 2 MPa and particularly a pressure of at least 3 MPa. These water jets coming from the high-pressure nozzles impact a baffle plate, where yet-to-be-recycled leftover concrete is located, which is preferably distributed from the baffle plate's reception section to the baffle plate's recycling section, where it is exposed to the water jets and then leaves the recycling chamber through the outlet opening. The water jets coming from the high-pressure nozzles permeate the leftover concrete located in the baffle plate's recycling section and impact the baffle plate. Compared to the recycling systems shown in prior art, where the leftover concrete located on a (vibrating) screen is sprayed with water (under much lower pressure), the water jets according to the invention that are ejected from the high-pressure nozzles cannot permeate the openings of a screen, but will impact the baffle plate that will reflect them at least in part because of the high pressure, or they will carom in part.

Because of the nozzles' high pressure, it is preferable to use fresh water or tap water. Otherwise, the high-pressure nozzles might be damaged for example by the fines contained in the gray water that is obtained when cleaning concrete transportation vehicles, concrete delivery vehicles or concrete pumps, if one were to use such gray water.

The baffle plate where the leftover concrete is located and where the high-pressure water jets impact is preferably designed as an essentially closed system. It does not, in particular, show any screen-like openings. With this combination of water jets under high pressure, on the one side, and a baffle plate instead of a screen, on the other, one can achieve that the water jets act like a cutting knife on the leftover concrete—i.e., that the connection of the cement paste adhering to the aggregates can be resolved or rather broken, thus preventing the concrete from setting or hardening.

The mixture leaving the outlet opening after such recycling treatment will still contain all components of the leftover concrete with far lesser amounts of water added, as compared to the solutions known from prior art. Without the recycling method according to the invention that uses high-pressure water jets impacting the baffle plate, such mixture would still become stiff and hard. But by recycling the leftover concrete located in the baffles' recycling section with the high-pressure water jets that permeate such leftover concrete and impact the baffle plate, the leftover concrete is deprived of its setting and hardening properties, so that the mixture of recycled leftover concrete emerging from the outlet opening can be stored or disposed of without having to break down such mixture into its individual components and without such mixture becoming stiff or hard. An additional breakdown of the mixture into its individual components, which we know from common recycling systems, is also possible even at a later point in time.

The leftover concrete recycling device provides for arranging the baffle plate and the high-pressure nozzles, which are used for generating the water jets that impact the baffle plate, in a recycling chamber, since, because of the water jets impacting the leftover concrete and subjacent baffle plate with high pressure, there is a repercussion of water that is mixed with concrete components. In order to be able to handle such repercussion of water that is mixed with concrete components, the leftover concrete recycling device features a recycling chamber where the baffle plate and the high-pressure nozzles are arranged. Preferably, the recycling chamber is essentially closed, and it preferably features no other openings apart from the inlet and outlet opening, to prevent high-pressure water from spurting out along with concrete components that may be stirred and raised by such high-pressure water.

Moreover, this kind of recycling allows for particularly small spaces, which, in turn, allows for the leftover concrete recycling device to be used on concrete transportation vehicles and/or concrete delivery vehicles. The leftover concrete recycling device can be transported on a concrete delivery vehicle, e.g. on a truck-mounted concrete pump, and—if necessary—can be positioned underneath the outlet opening of a truck-mounted concrete pump, in order to catch the leftover concrete generated at the beginning or end of concreting. The leftover concrete recycling device is dimensioned such that it can recycle the amount of leftover concrete that accrues when delivering one load of the conveyor system of a truck-mounted concrete pump. The recycling system is preferably dimensioned for a throughput of no more than 10 m³/h, for example no more than 5 m³/h, in particular no more than 3 m³/h. Due to the design and recycling method of the leftover concrete recycling device, the space required is particularly small: only the recycling chamber with the baffle and the high-pressure nozzles arranged above are necessary.

Preferably, the recycling chamber features a floor, side walls and an upper boundary.

The inlet opening is preferably arranged in the upper boundary area, while the outlet opening is preferably arranged on the floor. The inlet opening may feature, for example, a rectangular, oval or essentially circular cross section. It may, moreover, feature a funnel to facilitate the filling of leftover concrete through the inlet opening.

The outlet opening may feature, for example, a slot-type, strip-type or rectangular cross section. It is particularly preferable for the outlet opening to extend across the entire width of the baffle plate.

The inlet opening is preferably arranged at an upper side of the leftover concrete recycling device. Preferably, leftover concrete falls essentially by the force of gravity, preferably by free fall, through the inlet opening and onto the underneath-arranged reception section of the baffle plate. When the leftover concrete recycling device is in operating mode, the inlet opening is preferably arranged higher than the outlet opening. The direction, in which leftover concrete moves from the reception section of the baffle plate to the recycling section and then to the outlet opening, can be also referred to as recycling direction.

What is moreover preferred when the leftover concrete recycling device is in operating mode, is for the baffle plate to be horizontally tilted such that the reception section of the baffle plate close to the inlet opening is arranged higher than an end of the baffle plate close to the outlet opening. This way, leftover concrete filled onto the reception section of the baffle plate can get to the outlet opening via the recycling section of the baffle plate, preferably by the force of gravity. In order to achieve a good distribution of the leftover concrete on the baffle plate, the baffle plate is preferably designed rooftop-like, with a ridge running essentially in recycling direction. The ridge running preferably along a centerline may be a ridge-like elevation in the direction of the recycling direction of the baffle plate, from where two halves of the baffle plate are tilted downward.

The baffle plate may be moreover connected to a drive device that is designed and arranged to make the baffle plate vibrate. It is, in particular, preferred for the baffle plate and/or the drive device to be designed and arranged such that leftover concrete, which is located, in particular, in the reception section of the baffle plate, is distributed and/or leftover concrete is conveyed from the baffle plate's reception section and alongside the baffle plate's recycling section to the outlet opening. It is particularly preferred for the baffle plate and/or the drive device to be arranged and designed such that the yet-to-be-recycled leftover concrete in the recycling section of the baffle plate has a layer thickness of no more than twice the diameter of a maximum grain of yet-to-be-recycled leftover concrete, wherein it is particularly preferred for the layer thickness to essentially correspond to the diameter of a maximum grain of yet-to-be-recycled leftover concrete.

Such distribution of the yet-to-be-recycled leftover concrete in the recycling section of the baffle plate is preferred, as it allows for particularly good results as regards the mechanical separation of the cement paste from the aggregates by the high-pressure water jets.

In a preferred embodiment, the leftover concrete recycling device is characterized by a high-pressure pump that is arranged and designed such as to guide water to the high-pressure nozzles through a high-pressure water pipe.

It is particularly preferred for the high-pressure pump to be designed such as to build up water pressure of at least 1 MPa, preferably water pressure of at least 2 MPa, in particular water pressure of at least 3 MPa. What is moreover preferred is for the high-pressure pump to show a performance of no more than 20 kW, preferably no more than 10 kW, in particular no more than 5 kW. What is even further preferred is for the high-pressure pump to be designed such as to convey a water amount of no more than 50 l/min, preferably a water amount of no more than 30 l/min, in particular a water amount of no more than 20 l/min.

A particularly preferred pump design provides for a performance of 5 kW to convey 20 l/min at a pressure of 3 MPa.

The embodiment of the high-pressure pump for conveying water to the high-pressure nozzles through a high-pressure water pipe must, on the one hand, provide the high pressure that is required for the leftover concrete recycling device. At the same time, however, the performance and the water amount conveyed shall be preferably relatively small. Low performance of the high-pressure pump has the advantage that the pump can be small in size, which makes it easier for the leftover concrete recycling device to be used on a concrete transportation vehicle or a concrete delivery vehicle. Conveying a relatively small amount of water will, on the one hand, save water, which is facilitated by the fact that the leftover concrete recycling device does not require a large amount of water to dilute the leftover concrete, but that water is used in form of a high-pressure water jet only for mechanical separation of the cement paste from the concrete aggregates—quasi to break the link between cement paste and aggregates. This way, a considerable amount of fresh water can be saved as compared to common concrete recycling devices to achieve a desired water excess, in particular a desired water/cement (w/c) ratio. By recycling the leftover concrete by means of high-pressure water jets, much more water can be introduced to the cement paste mixture (and hence a higher w/c ratio can be achieved) than with existing systems. At the same time, much less water is required overall. Also, the low water consumption allows for the leftover concrete recycling device to be smaller in size, which—in turn—allows for the system to be used on a concrete transportation vehicle and/or concrete delivery vehicle.

Another preferred embodiment of the leftover concrete recycling device provides for the recycling chamber to feature a cover that is preferably removable. What is moreover preferred is for the upper cover, which is preferably detachably connectable to the side walls of the recycling chamber, to be connectable to the remaining housing, preferably to the side walls, of the recycling chamber such, during operation, that the recycling chamber is essentially closed, except for the inlet opening and the outlet opening. The inlet opening is preferably located in the upper cover. The high-pressure nozzles and, possibly, a high-pressure water pipe for feeding water to the high-pressure nozzles are moreover preferably arranged at the inside of the upper cover. The fact that the upper cover can be removed makes it easier to access the high-pressure nozzles.

The leftover concrete recycling device can be preferably designed such as to let heated water exit the high-pressure nozzles. To that end, the leftover concrete recycling device may, for example, feature a corresponding heating unit for the high-pressure water. The water is preferably heated to a temperature above 30° C., in particular to a temperature between 40 and 60° C. This has the advantage that the water of the water jets will have a lower surface tension than the water already contained in the cement paste, which improves the absorption of the water jets' water by the leftover concrete. This allows, in particular, for a faster accumulation of water in the cement paste and smaller amounts of water that need to be added overall. What is particularly preferred is a w/c ratio of between 0.6 and 1, to prevent or reduce the setting and hardening of the concrete.

Another preferred embodiment of the leftover concrete recycling device is that the high-pressure nozzles are arranged and designed such that the water jets coming from the high-pressure nozzles impact the baffle plate's recycling section in a strip-type area.

It has shown that with such kind of arrangement of the high-pressure nozzles, with a strip-type impact area in the recycling section of the baffle plate, the connection between cement paste and aggregates can be broken particularly efficiently by the water jets.

Preferably, the length of the strip-type area extends across the better part of the baffle plate's width, in particular across the entire width of the baffle plate. This way, it can be ensured that all of the leftover concrete that is located on the baffle plate and needs to be recycled will pass the water jets, and that all of the leftover concrete will be recycled in a reliable manner. Furthermore, preferably, the strip-type area is arranged essentially orthogonally to a recycling direction.

It is particularly preferred for the strip-type area to have a width that corresponds to no more than twice the diameter of a maximum grain of yet-to-be-recycled leftover concrete.

The strip-type area may have a width of, for example, no more than 10 cm, preferably no more than 7.5 cm, in particular no more than 5 cm. It has shown that a small width of the strip-type area, where the water jets impact the leftover concrete and the subjacent baffle plate, is not only sufficient but may even increase the water jets' separating effect. This way, it can be ensured that the high pressure, at which the water jets are delivered from the high-pressure nozzles, can be essentially passed on to the leftover concrete in the strip-type area to achieve an as good and reliable as possible separation of the cement paste from the aggregates.

In another embodiment of the leftover concrete recycling device, the high-pressure nozzles are arranged and designed such that the water jets delivered from the high-pressure nozzles impact the baffle plate's recycling section in two, three or more strip-type areas that are preferably arranged in a row in recycling direction. Preferably, the respective strip-type areas are designed as described hereinabove.

By arranging several rows of high-pressure nozzles or, rather, water jets in a row, the quality and reliability of separation of the cement paste from the aggregates by the water jets can be even improved.

A preferred embodiment of the leftover concrete recycling device is further characterized by two, three or more cleaning nozzles, which are arranged and designed to clean the recycling chamber, in particular the high-pressure nozzles and/or the side walls and/or the upper cover and/or the baffle.

When recycling leftover concrete with high-pressure water jets that impact the baffle and carom in part, the inside (incl. the high-pressure nozzles) of the recycling chamber of the leftover concrete recycling device is, itself, heavily polluted by the leftover concrete components that are stirred and raised by the high-pressure water jets and their repercussion. Since the leftover concrete components thus stirred still have their setting and/or hardening properties, at least in part, those parts of the leftover concrete recycling device that get in contact with them, especially the inside surfaces of the recycling chambers and the high-pressure nozzles, must be cleaned at regular intervals, to prevent the stirred leftover concrete components from setting and hardening. To that end, the cleaning nozzles that are preferably connected to a water pipe are filled with water and/or a cleaning liquid. The cleaning nozzles may be arranged on an inner surface of the upper cover.

The cleaning nozzles are arranged in their spray direction or, rather, spray angle preferably such that their spray jets can easily reach the recycling chamber and, in particular, the high-pressure nozzles, side walls, upper cover and/or baffle. The cleaning nozzles are preferably arranged such that they can also spray and clean the respective other cleaning nozzles. To that end, the cleaning nozzles are also filled preferably with water or cleaning liquid at high pressure, preferably at the same pressure at which the high-pressure nozzles are charged. The cleaning nozzles are preferably connected to the same water supply and/or high-pressure pump as the high-pressure nozzles.

It is further preferred for the leftover concrete recycling device to feature a control unit that is arranged and designed to start and/or stop the supply of water and/or cleaning liquid from the cleaning nozzles. It is particularly preferred for the control unit to be designed such as to automatically start and/or stop the supply of water and/or cleaning liquid from the cleaning nozzles at certain intervals. This way, one can perform preferably pre-programmed cleaning cycles, to ensure a regular cleaning of the recycling chamber and high-pressure nozzles.

It is further preferred for the control unit to be arranged and designed such as to also start and/or stop the supply of water from the high-pressure nozzles and/or to start and/or stop the drive device. This embodiment is particularly preferred, if the control unit is also arranged and designed to allow for an alternating operation of the cleaning nozzles and the high-pressure nozzles.

Such alternating operation of the cleaning nozzles and high-pressure nozzles may also comprise the drive device, which is preferably started and/or stopped at the same time as the high-pressure nozzles. This way, in terms of cyclic cleaning, the recycling of leftover concrete (by the high-pressure water jets and possibly through vibration of the baffle plate) can be stopped during cleaning, while cleaning can be stopped during the recycling of leftover concrete. This allows for a very efficient cleaning and very short cleaning times.

It is further preferred for a first group of cleaning nozzles to be arranged and designed to clean an area in recycling direction behind the high-pressure nozzles, in particular in recycling direction behind a strip-type area, where the water jets impact, in particular in alternating operation with the high-pressure nozzles. It is further preferred for a second group of further cleaning nozzles to be provided, which are arranged and designed to clean an area in recycling direction before the high-pressure nozzles, in particular in recycling direction before a strip-type area, where the water jets impact, in particular after completion of the recycling of a certain amount of leftover concrete. Dividing the cleaning nozzles into two groups has the advantage that that part of the recycling chamber, which is particularly affected by the water jets' repercussion, can be cleaned periodically, while the entrance area of the recycling chamber, into which the leftover concrete to be recycled is filled, is cleaned only at the end of a recycling sequence, once no new leftover concrete is filled in.

Another preferred embodiment of the leftover concrete recycling device provides for two, three or more baffles, preferably stacked in vertical direction, with dedicated high-pressure nozzles. The respective baffles with dedicated high-pressure nozzles may be arranged in individual recycling chambers or in one common recycling chamber. Preferably, the inlet opening of a second recycling chamber is formed by the outlet opening of a first recycling chamber. If the several baffles with dedicated high-pressure nozzles are arranged in one common recycling chamber, there will be openings between the baffles, preferably at the end of each baffle, through which the leftover concrete recycled on the first baffle with dedicated high-pressure nozzles can get to the next baffle and thus to the next recycling step. What is particularly preferred is a (when seen in cross section) zigzagged arrangement of tilted baffles with an accordingly zigzagged recycling direction of the leftover concrete. This way, one can achieve a multiplication of the recycling path—while, in particular, maintaining the base area of the leftover concrete recycling device and only slightly increasing its height—and thus improve recycling quality and reliability.

Another preferred embodiment of the leftover concrete recycling device is characterized by one, two or more separators that are designed and arranged to separate the recycled leftover concrete according to its components, in particular into aggregates, preferably by different particle size, cement paste and/or gray water. For example, a screen or centrifuge may be used as a separator. This embodiment serves to break down the recycled leftover concrete, which has already lost its setting and/or hardening property, possibly after transportation or storing, into its original components, or to remove some specific of these original components in order to make them available for the production of new fresh concrete.

What is particularly preferred is an embodiment of the leftover concrete recycling device that is characterized by the leftover concrete recycling device having a base area that is smaller than, or equal to, a standardized pallet, in particular a europool pallet.

Preferably, the leftover concrete recycling device has a length of no more than 1200 mm and a width of no more than 800 mm. If the leftover concrete recycling device according to these embodiments has such a small base, it can be easily transported, in particular on a concrete delivery vehicle. Many concrete delivery vehicles have a setup area that equals the size of a europool pallet. What is hence particularly preferred is for the leftover concrete recycling device to also have a maximum base that equals such a europool pallet, so that it can be mounted in the setup area of concrete delivery trucks.

It is further preferred for the leftover concrete recycling device to be so compact in size that it can be mounted, directly or spaced, to the supply funnel of, or transported by, a concrete delivery vehicle as an add-on element, so that the leftover concrete recycling device does not have to be relocated once it needs to be used, but can remain in its place of installation.

It is further preferred for the leftover concrete recycling device to have a height of no more than 1 m, preferably no more than 90 cm, in particular no more than 80 cm. It is particularly preferred for the leftover concrete recycling device to have a height that is smaller than, or equal to, half the height of a standardized ISO container, preferably smaller than, or equal to, one third of the height of a standardized high cube ISO container.

These embodiments have several advantages: on the one hand, such limited height allows for the leftover concrete recycling device to be used on a plurality of concrete transportation and/or concrete delivery vehicles, because a leftover concrete recycling device with such limited height can be normally arranged below the supply funnel or supply pipe of a concrete transportation or concrete delivery vehicle. This way, the leftover concrete recycling device can be not only easily transported on a concrete transportation or concrete delivery vehicle, but it can be also easily removed from its place of installation on the concrete transportation or concrete delivery vehicle and placed below a concrete transportation or concrete delivery vehicle's supply funnel or supply pipe for fresh concrete once that vehicle has reached its destination, in order to recycle leftover concrete directly at its point of origin. Once such recycled leftover concrete has lost its setting and/or hardening properties, it can be either stored or transported over longer distances, since one does not have to comply with a specific, short timeframe before the concrete becomes stiff and hard.

On the other hand, such limited height has the advantage that several leftover concrete recycling devices can be stacked in a standardized ISO container. Also, the leftover concrete recycling device may be arranged, for example, in a rack, whose base area equals that of a standardized ISO container and whose height equals, for example, half or one third of the height of such standardized ISO container. This way, the leftover concrete recycling device arranged in such a rack may be either combined into such an ISO container with further such leftover concrete recycling devices that are arranged in a rack, or even with other racks that also equal, for example, half or one third or two thirds of the height of a standardized ISO container, and transported accordingly. It is particularly preferred for a leftover concrete recycling device arranged in a rack to be capable of being combined into a standardized ISO container together with a concrete delivery device that is preferably also arranged in a rack, and possibly even with other racks, for example for a concrete delivery drive, air-conditioning and/or noise absorption.

In order to realize an as low as possible height of the leftover concrete recycling device, it is particularly preferred for the distance between the high-pressure nozzles and the recycling section of the baffle plate to be no more than 80 cm, preferably no more than 60 cm, in particular no more than 40 cm.

According to yet another aspect of the invention, the above-referenced object is solved by a mobile concrete recycling arrangement comprising a leftover concrete recycling device, as described hereinabove, one, two or more receptacles for aggregates, preferably of different particle size, cement paste and/or gray water, a discharge device for aggregates, preferably of a specific particle size, and a fresh water tank in fluid connection with a water pipe of the leftover concrete recycling device.

Preferably, such a mobile concrete recycling arrangement can be upgraded by arranging all components of the concrete recycling arrangement in a rack or housing, whose dimensions correspond to a standardized ISO container—in particular, whose base area corresponds to the base area of a standardized high cube ISO container—and whose height is smaller than, or equal to half—in particular smaller than, or equal to a third of—the height of a standardized high cube ISO container. Moreover, the base area of the concrete recycling device may also equal part—preferably half, one third or one quarter—of the base area of a standardized ISO container.

As regards the advantages, types of embodiments and embodiment details of this further aspect of the invention and its embodiments, reference is made to the above description of the respective features of the leftover concrete recycling device. One particular advantage of the mobile concrete recycling arrangement is that it can be used as a module, for example, in a precast plant below a concrete delivery pump, to, on the one hand, directly recycle the leftover concrete accruing in a precast concrete component such that it will lose its setting and/or hardening properties, and to then break up such leftover concrete, at least partially, into its original components, so that these components can be reused in the production of fresh concrete.

According to another aspect of the invention, the above-referenced object is solved by a method for leftover concrete recycling, in particular by means of a leftover concrete recycling device, as described hereinabove, comprising the following steps: Filling leftover concrete, which needs to be recycled, through an inlet opening onto the reception section of a baffle plate in a recycling chamber, recycling the leftover concrete on the recycling section of the baffle plate in the recycling chamber by means of water jets that are delivered from high-pressure nozzles and impact the recycling section of the baffle plate, discharging the recycled leftover concrete from the recycling chamber through an outlet opening.

This method and its potential embodiments have features or method steps, which make them particularly suitable for being used together with a leftover concrete recycling device according to the invention and its embodiments.

As regards the advantages, types of embodiments and embodiment details of this method and its embodiments, reference is made to the above description of the respective features of the leftover concrete recycling device.

Preferred embodiments of the invention are described by way of example based on the enclosed figures, which show the following:

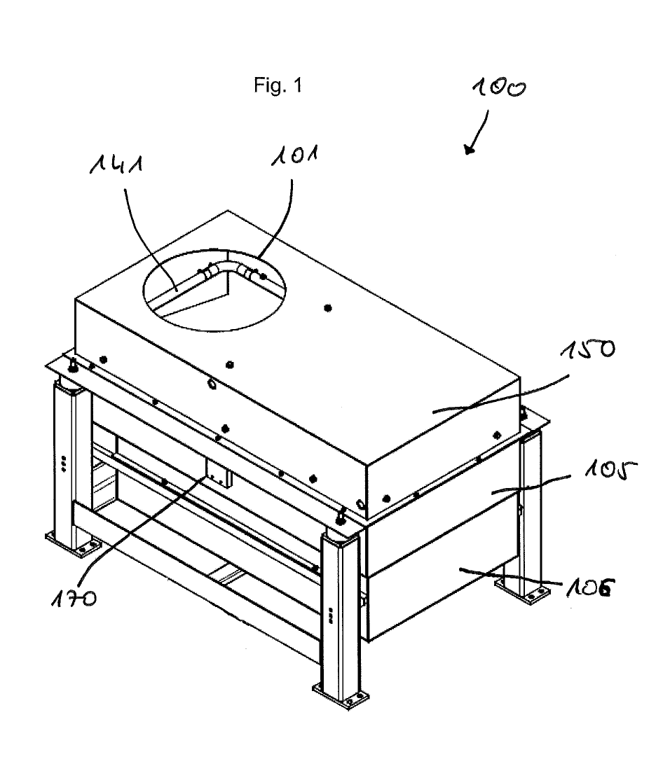

FIG. 1 shows a three-dimensional view of a leftover concrete recycling device;

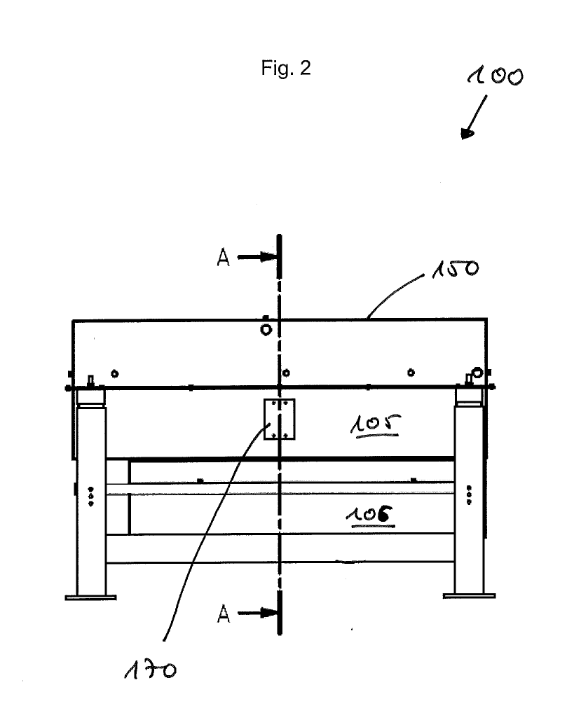

FIG. 2 shows a lateral view of the leftover concrete recycling device according to FIG. 1;

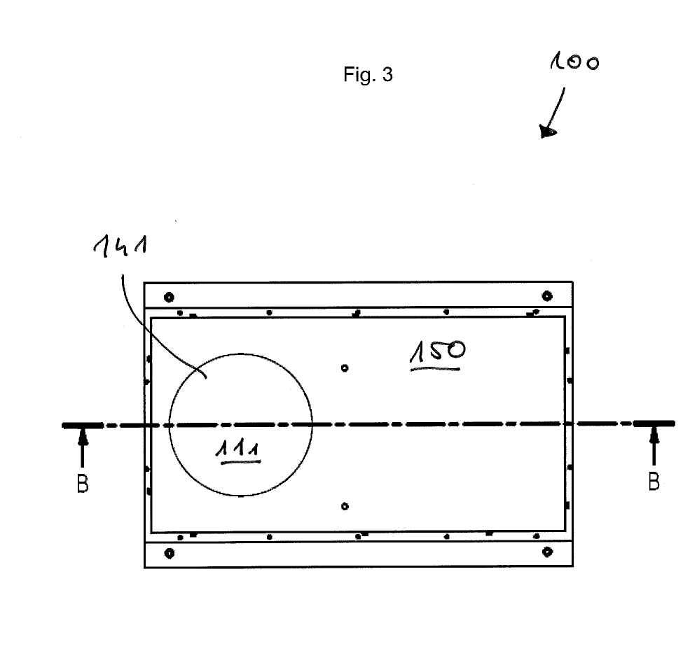

FIG. 3 shows a top view of the leftover concrete recycling device according to FIG. 1;

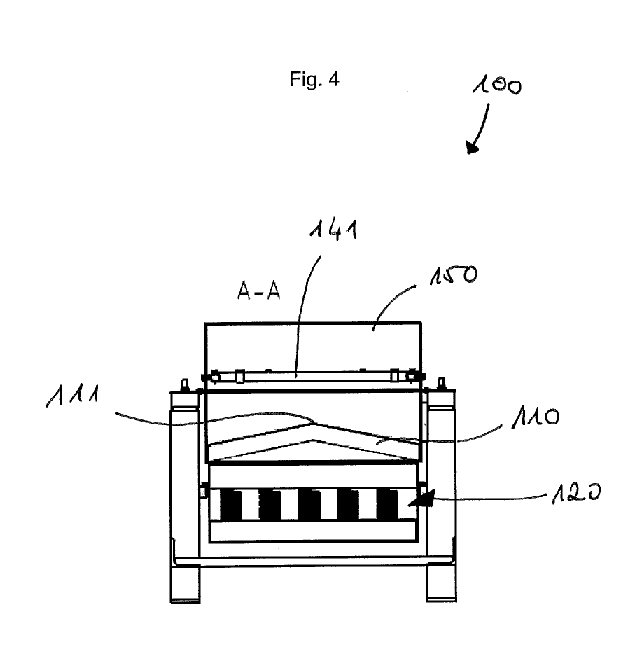

FIG. 4 shows a sectional view along sectional plane A-A from FIG. 2;

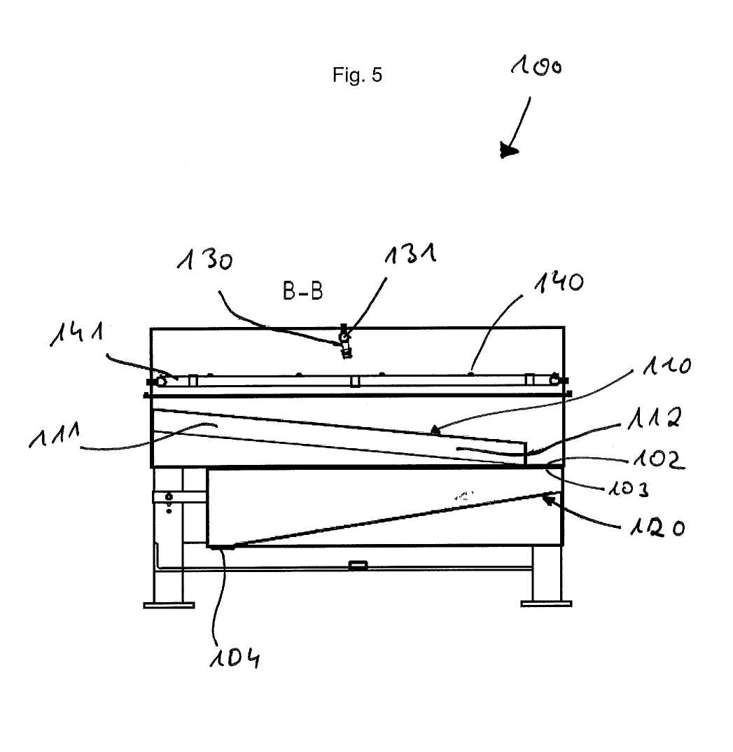

FIG. 5 shows a sectional view along sectional plane B-B from FIG. 3;

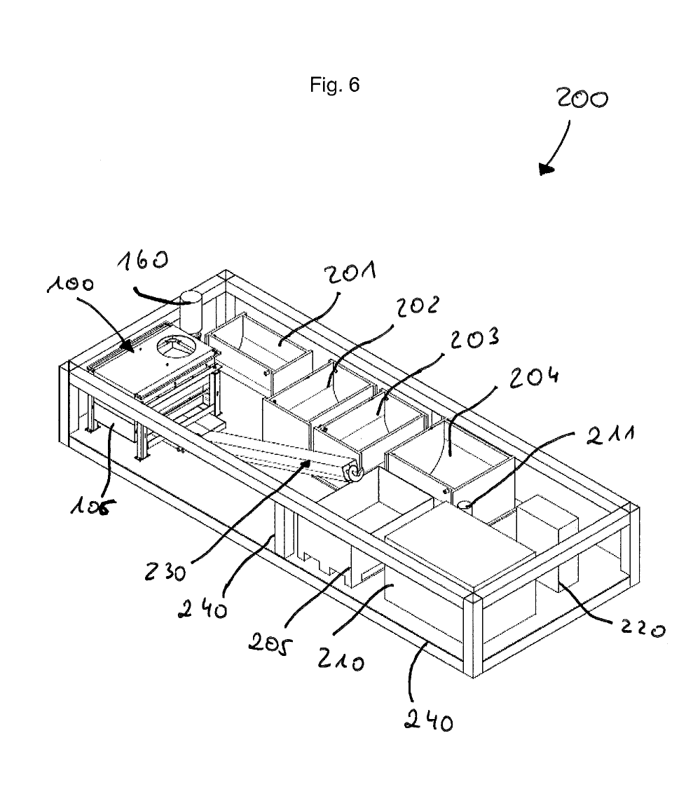

FIG. 6 shows a three-dimensional view of a mobile concrete recycling arrangement;

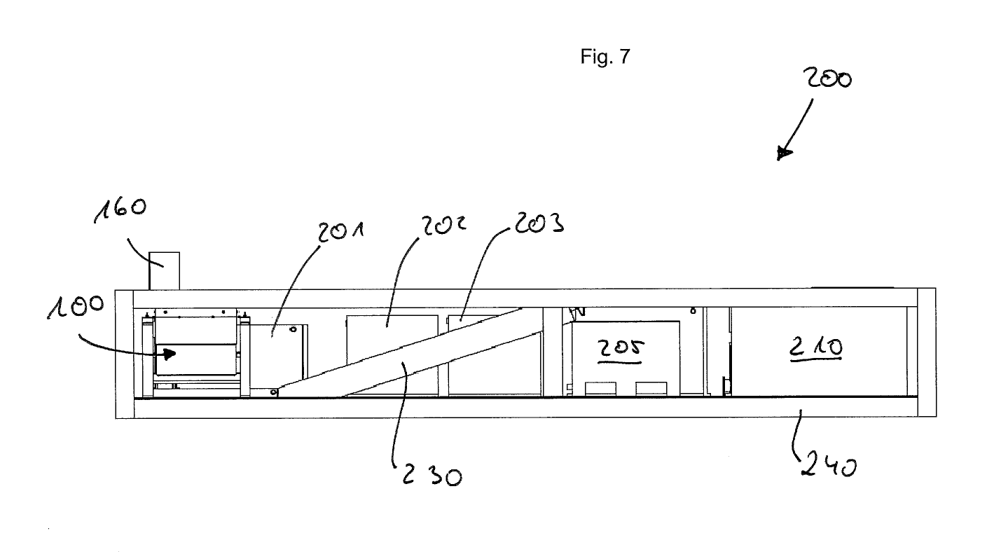

FIG. 7 shows a lateral view of the concrete recycling arrangement according to FIG. 6;

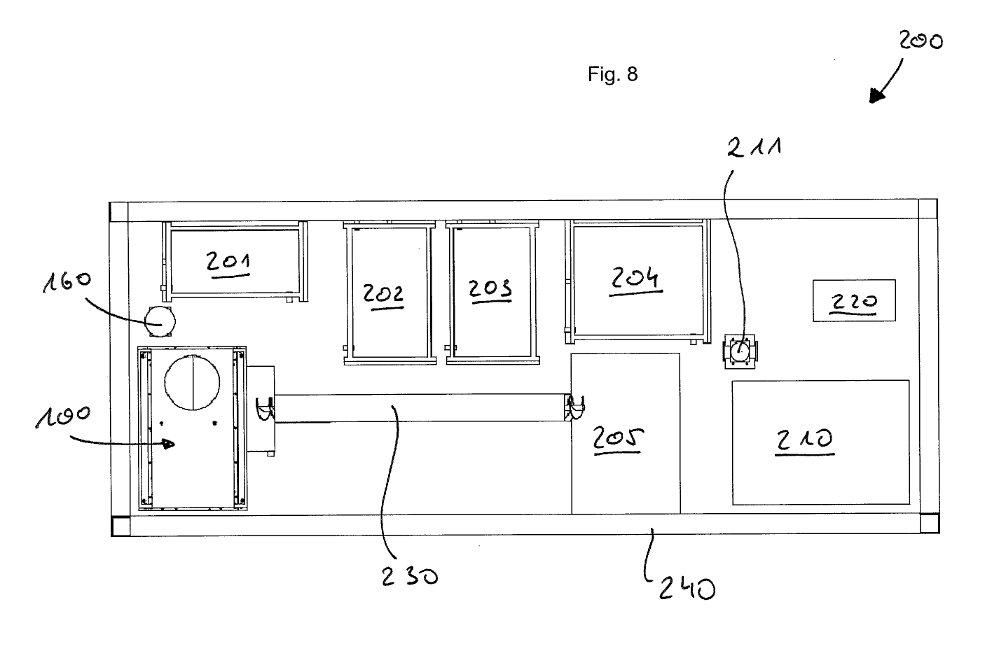

FIG. 8 shows a top view of the concrete recycling arrangement according to FIG. 6;

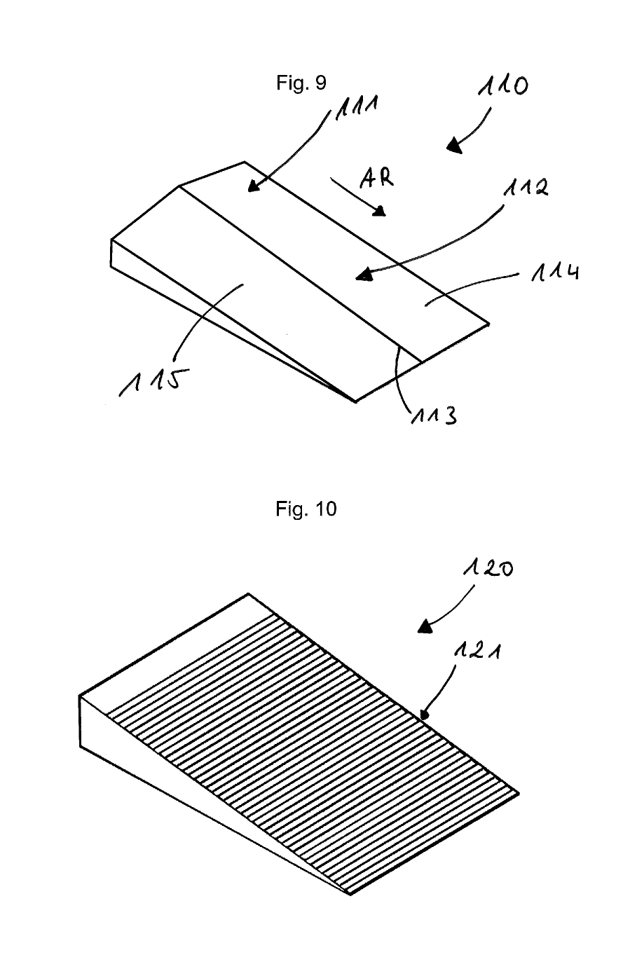

FIG. 9 shows a three-dimensional view of a first baffle for the leftover concrete recycling device according to FIG. 1; and

FIG. 10 shows a three-dimensional view of a second baffle for the leftover concrete recycling device according to FIG. 1.

FIGS. 1 to 5 show a leftover concrete recycling device 100 according to the invention for mobile use on a concrete transportation or concrete delivery vehicle. This leftover concrete recycling device 100 is particularly compact, with a base area that equals the base area of a standardized europool pallet, having a length of no more than 1200 mm and a width of no more than 800 mm. The height of the depicted leftover concrete recycling device is no more than 80 cm. Having these dimensions, the leftover concrete recycling device can be transported, on the one hand, on the europool pallet setup area of, in particular, a concrete delivery vehicle, and used, on the other, below the supply funnel or supply pipe of a concrete transportation or concrete delivery vehicle.

The leftover concrete recycling device 100 features a removable upper cover 150, which has a circular inlet opening 101 for leftover concrete. A high-pressure water pipe 131 with high-pressure nozzles 130, which can be also referred to as working or recycling nozzles, is arranged on the inner surface of the upper cover 150, as shown in particular in FIG. 5. FIGS. 1, 4 and 5, in particular, show cleaning nozzles 140 that are again arranged on the inside of the upper cover 150 and connected to a water pipe 141.

The inside of device 100 features a reception chamber with a baffle plate 110 designed like a baffle with a reception section 111 that is formed below the inlet opening 101 and followed by a recycling section 112, which is arranged close to the outlet opening 102. Below that recycling chamber, in vertical direction, there is a second chamber with a second baffle 120, whose inlet opening 103 corresponds to the outlet opening 102 of the recycling chamber and whose outlet opening 104 is formed at the end of the second baffle 120.

The two baffles 110 and 120 are shown once again in detail in FIGS. 9 and 10. The first baffle 110 is formed rooftop-like, with a ridge 113 running essentially in recycling direction RD. This ridge-like elevation 113 divides the baffle 110 approximately in the center, with the two sections 114 and 115 being laterally tilted downwards. In a first tilt direction, the baffle 110 is inclined towards the horizontal such that when the leftover concrete recycling device 100 is in operating mode, the reception section 111 of the baffle plate close to the inlet opening 101 is arranged higher than one end of the baffle plate that is close to the outlet opening 102.

The second baffle plate 120 is also inclined towards the horizontal and is furthermore equipped with a wave-like surface 121. This second baffle plate 120 may also carry creases that are not only arranged continuously, as shown in FIG. 10, but the creases may be non-continuous or even formed as diamond plates (e.g. as a so-called Nippon floor or according to DIN 51130), as suggested in FIG. 4. Moreover, there may be openings in the second baffle plate, or baffle plate 120 may be formed as a screen, since the closed baffle plate that is required for recycling is already provided in form of baffle plate 110 and therefore the second baffle plate 120 may also assume other functions, such as a screening and/or separating function and/or a deceleration of the delivery of recycled leftover concrete.

The outlet opening 102 is formed slot-like, strip-type or rectangular at the end of baffle plate 110 and extends across the entire width of the baffle plate 110. The inlet opening 101 is arranged at an upper end of the leftover concrete recycling device 100, and when the leftover concrete recycling device 100 is in operating mode, said inlet opening is arranged higher than the outlet opening 102. From there, the leftover concrete to be filled into the inlet opening 101 can fall essentially by the force of gravity, preferably by free fall, onto the reception section 111 of the baffle plate 110. From there, the leftover concrete falls preferably also by the force of gravity, possibly aided by a vibrating drive, onto the reception section 112 of the baffle plate, and from there to outlet opening 102. From this outlet opening 102, which serves at the same time as inlet opening 103, the recycled leftover concrete reaches the second baffle 120, and from there, by the force of gravity, to the lower end of the second baffle 120, where it leaves the leftover concrete recycling device 100 through outlet opening 104.

The design of the baffle 110, which is shown in particular in FIG. 9, allows for a particularly good and even distribution of the leftover concrete on the baffle plate 110 and, in particular, on the recycling section 112. This distribution and the delivery of the leftover concrete via baffle plate 110 may be additionally supported by a vibrating drive, which can be arranged, for example, at the connection points 170 of the side walls 105 of the recycling chamber.

The recycling chamber has side walls 105, with which the upper cover 150 can be connected in a detachable manner. The lower chamber, where the baffle 120 is arranged, also has side walls 106.

The high-pressure nozzles 130 are arranged and designed such that leftover concrete located on recycling section 112 of the baffle plate 110 is permeated, in a strip-type area, by water jets delivered from the high-pressure nozzles 130. These water jets impact the recycling section 112 of the baffle plate 110, from where they are thrown back into the reception chamber. The high-pressure nozzles 130 are connected to a high-pressure pump 160 through a high-pressure water pipe 131 (see FIGS. 6 to 8). This high-pressure pump 160 produces a pressure of preferably 3 MPa, pumping 20 liters of water per minute to the high-pressure nozzles at a rate of approx. 5 kW.

With this type of recycling that uses water jets that are so highly pressurized, the inside of the recycling chamber is largely splattered with leftover concrete components. Even though when leaving the outlet opening 102, the recycled leftover concrete has essentially lost its setting and/or hardening properties after having been exposed to the high-pressure water jets, the leftover concrete components splattered on the inside walls of the reception section still have these properties, albeit possibly in reduced form. Cleaning nozzles 140 are provided for cleaning the recycling chamber and, in particular, the high-pressure nozzles 130 and high-pressure water pipe 131 arranged therein; these cleaning nozzles are supplied by a water pipe 141 and clean the recycling chamber and the high-pressure nozzles 130 and the high-pressure pipe 131 at regular intervals with water or cleaning liquid, in particular based on a cyclical, automatically controlled cleaning program. The cleaning nozzles 140 are preferably arranged, designed and aligned such as to also clean other cleaning nozzles 140 and/or the water pipe 141. The baffle 110 is preferably also cleaned by the cleaning nozzles 140, in particular, when there is no more leftover concrete left in the leftover concrete recycling device 100.

As can be seen in FIGS. 6 to 8, a leftover concrete recycling device 100 according to the invention can be integrated in a mobile concrete recycling arrangement 200. The concrete recycling arrangement 200 features a cement paste container 201, three gray water containers 202, 203, 204, a container 205 for aggregates with stone particles that are discharged from the leftover concrete recycling device 100 via a delivery screw 230, a fresh water tank 210 with a dedicated booster pump 211 and a control cabinet 220. The components of the mobile concrete recycling arrangement 200 are arranged in a rack 240, whose base area equals that of a standardized ISO container. Preferably, the height of that rack 240 corresponds to one third of a standardized high cube ISO container. Preferably, all components of the mobile concrete recycling arrangement 200 are arranged within the space that is defined by the rack 240.

Preferably, the high-pressure pump 160 projecting beyond the rack 240 in the depicted example is dimensioned such that it will not project beyond the rack 240 but, as all other components, will remain arranged in the space defined by the rack 240.

The rack 240 preferably features fasteners and fixing devices that are common in containers, so that the mobile concrete recycling arrangement can be, on the one hand, moved and transported like a container, and, on the other, combined into an overall rack together with other mobile concrete recycling arrangements or other equipment that is arranged in similar racks, whose dimensions correspond to that of a standardized ISO container. If the mobile concrete recycling arrangement 200 has the low profile of one third of the height of a standardized ISO container, preferably of a high cube ISO container, as shown herein, it has the advantage that there are still two thirds of the height of the standardized ISO container available for yet another module arranged in a rack, which may, for example, accommodate the elements of a concrete pump. What is particularly preferred is a combination of a mobile concrete recycling arrangement and a concrete delivery system, whose racks can be combined to form a standardized ISO container. Another preferred combination is one that forms a standardized ISO container comprising a mobile concrete recycling arrangement, a concrete delivery system and a drive device (possibly with air-conditioning and noise absorption), each of which is arranged in a rack.

1. A compact leftover concrete recycling device (100) for mobile use on a concrete transportation vehicle and/or concrete delivery vehicle, comprising a recycling chamber with a baffle plate (110), an inlet opening (101) for leftover concrete and an outlet opening (102) for recycled leftover concrete as well as two, three or more high-pressure nozzles (130), wherein the baffle plate, the inlet opening and the outlet opening are designed and arranged such that leftover concrete filled into the recycling chamber through the inlet opening impacts a reception section (111) of the baffle plate, passes a recycling section (112) of the baffle plate and then leaves the recycling chamber through the outlet opening, and wherein the high-pressure nozzles are arranged and designed such that water jets delivered from the high-pressure nozzles impact the recycling section of the baffle plate.

2. The leftover concrete recycling device (100) according to claim 1, characterized by a high-pressure pump (160) that is arranged and designed such as to conduct water to the high-pressure nozzles (130) through a high-pressure water pipe (131).

3. The leftover concrete recycling device (100) according to claim 2, characterized in that the high-pressure pump (160) is designed to build up water pressure of at least 1 MPa, preferably water pressure of at least 2 MPa, in particular water pressure of at least 3 MPa.

4. The leftover concrete recycling device (100) according to claim 1, characterized in that the recycling chamber features an upper cover (150), which is preferably designed as a removable cover.

5. The leftover concrete recycling device (100) according to claim 1, characterized in that the high-pressure nozzles (130) are arranged and designed such that the water jets delivered from the high-pressure nozzles impact the recycling section (112) of the baffle plate (110) in a strip-type area.

6. The leftover concrete recycling device (100) according to claim 1 characterized in that the strip-type area has a width that corresponds to no more than twice the diameter of a maximum grain of yet-to-be-recycled leftover concrete.

7. The leftover concrete recycling device (100) according to claim 1, characterized by two, three or more cleaning nozzles (140) that are arranged and designed to clean the recycling chamber, in particular the high-pressure nozzles (130) and/or the side walls (105) and/or the upper cover (150) and/or the baffle (110).

8. The leftover concrete recycling device (100) according to claim 1, characterized by a control unit that is arranged and designed to start and/or stop the supply of water and/or cleaning liquid from the cleaning nozzles (140).

9. The leftover concrete recycling device (100) according to claim 2, characterized in that the control unit is arranged and designed to allow for an alternating operation of the cleaning nozzles (140) and the high-pressure nozzles (130).

10. The leftover concrete recycling device (100) according to claim 1, characterized in that the leftover concrete recycling device has a base area that is smaller than, or equal to, a standardized pallet, in particular a europool pallet.

11. The leftover concrete recycling device (100) according to claim 1, characterized in that the leftover concrete recycling device has a height of no more than 1 m, preferably no more than 90 cm, in particular no more than 80 cm.

12. The leftover concrete recycling device (100) according to claim 1, characterized in that the leftover concrete recycling device has a height that is smaller than, or equal to, half the height of a standardized ISO container, preferably smaller than, or equal to, one third of the height of a standardized high cube ISO container.

13. A mobile concrete recycling arrangement (200), comprising
a leftover concrete recycling device (100) according to claim 1,
one, two or more receptacles for aggregates (205), preferably of different particle size, cement paste (201) and/or gray water (202, 203, 204),
a discharge device for aggregates (230), preferably of a specific particle size,
a fresh water tank (210) in fluid connection with a water pipe of the leftover concrete recycling device.

14. The mobile concrete recycling arrangement (200) according to claim 13, characterized in that all components of the concrete recycling arrangement are arranged in a rack (240) or housing, whose dimensions correspond to a standardized ISO container—in particular, whose base area corresponds to the base area of a standardized high cube ISO container—and whose height is smaller than, or equal to half—in particular smaller than, or equal to a third of—the height of a standardized high cube ISO container.

15. A method for leftover concrete recycling, in particular by means of a leftover concrete recycling device (100) according to claim 1, comprising the following steps:
Filling leftover concrete, which needs to be recycled, through an inlet opening (101) onto the reception section (111) of a baffle plate (110) in a recycling chamber,
recycling the leftover concrete on the recycling section (112) of the baffle plate (110) in the recycling chamber by means of water jets that are delivered from high-pressure nozzles (130) and impact the recycling section of the baffle plate,
discharging the recycled leftover concrete from the recycling chamber through an outlet opening (102).
